(19) United States
(12) Patent Application Publication
(10) Pub. No.: US 2010/0009581 A1
(43) Pub. Date: Jan. 14, 2010

(54) MEANS FOR FIRE PROTECTION OF PIPES, PIPE JOINTS, FLANGES, VALVES, INSULATION AND STEEL CONSTRUCTIONS

(76) Inventor: Magne Stenseide, Kjerrgarden (NO)

Correspondence Address: FROMMER LAWRENCE & HAUG, 745 FIFTH AVENUE- 10TH FL., NEW YORK, NY, 10151, US

(21) Appl. No.: 12/440,665

(22) PCT Filed: Sep. 20, 2006
(86) PCT No.: PCT/NO06/00321

§ 371 Date: Jun. 29, 2009

(51) Int. Cl. F16L 57/04

(52) U.S. Cl. 442/1; 528/421

(57) ABSTRACT

Means for fire protection of pipes, pipe joints, flanges, valves, insulation and steel constructions, where the fire protection (1) is made flexible and made of heat expanding epoxy material (2) with or without reinforcement (3).

The present invention is related to a means for fire protection of pipes, pipe joints, flanges, valves, insulation and steel constructions. More specific to a flexible and expanding epoxy mat applied as fire protection.

In case of fire in or on pipes, pipe joints, flanges, valves, insulation and steel constructions it is important that these are secured in the best possible way and additionally maintain their functionality as long as possible during fire. The fire protection should provide documentation for resistance against fire loads such as jet fires and hydrocarbon fire.

With the means for fire protection according to the present invention as defined by the features stated in the claims, the above mentioned objectives are secured.

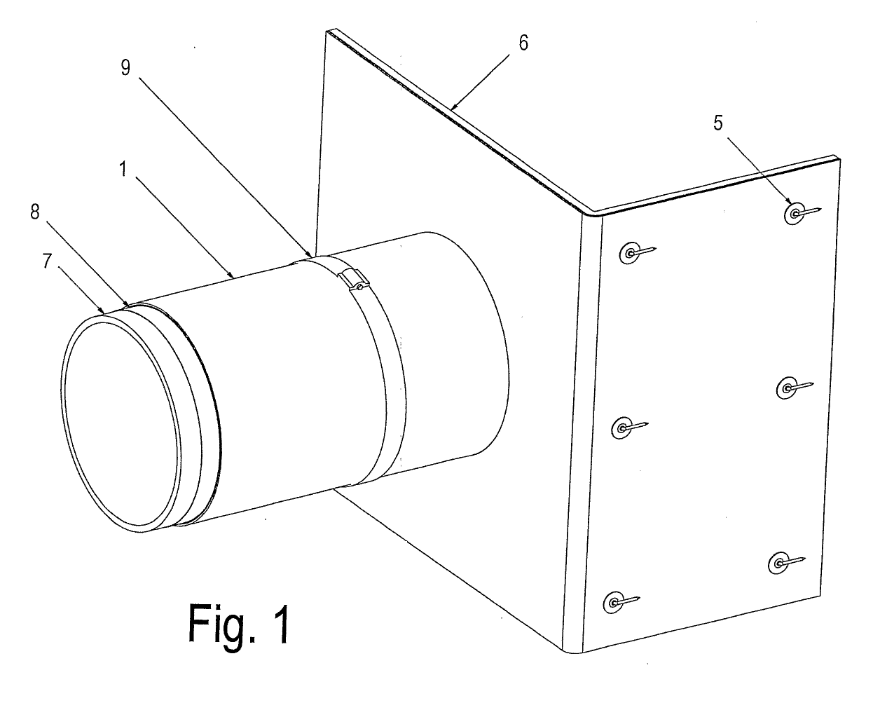

The drawing discloses in FIG. 1 the use of a flexible fire protection according to the invention on a pipe and on a steel construction;

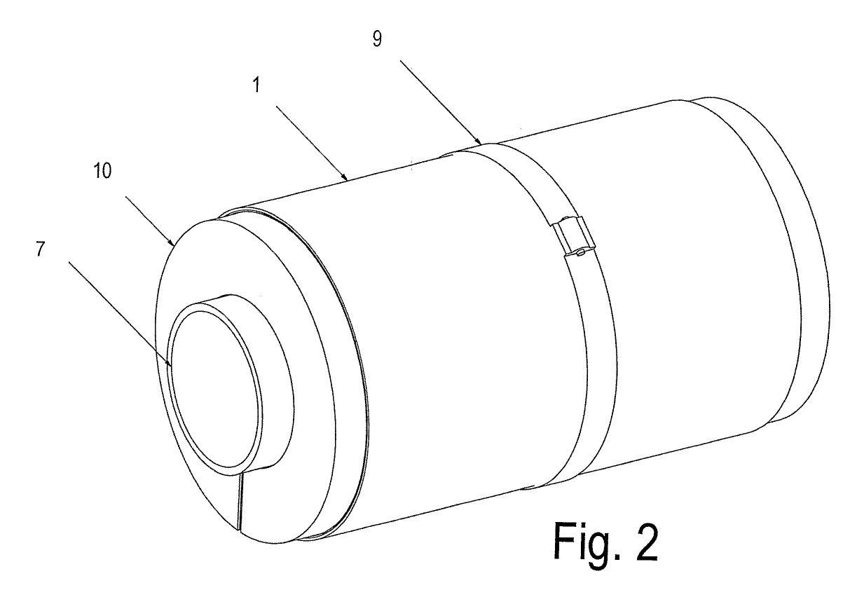

FIG. 2 discloses the use of a flexible fire protection according to the invention on insulation; and

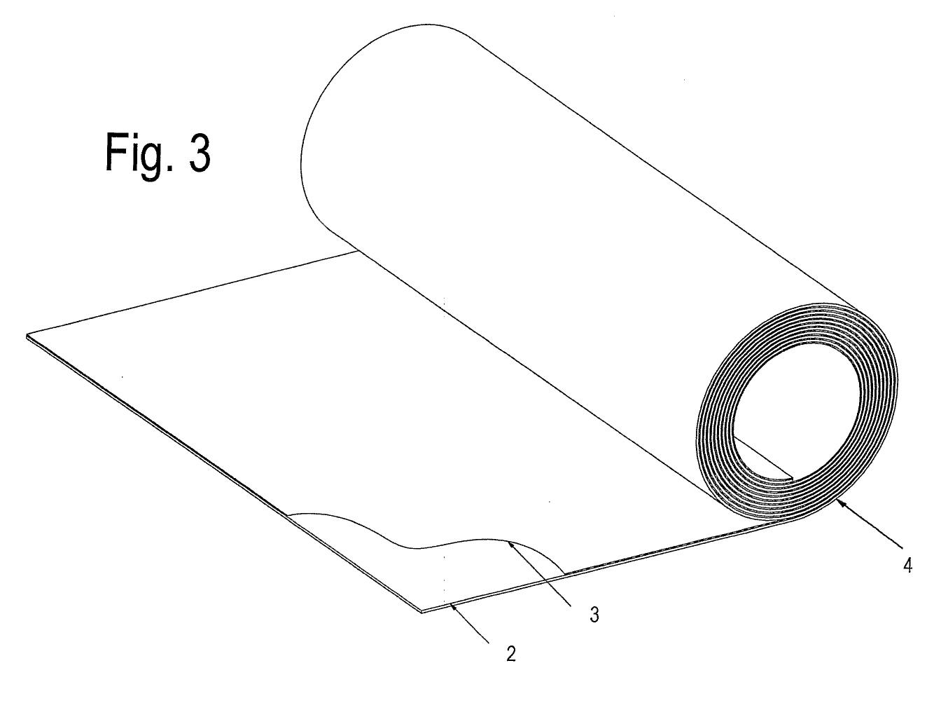

FIG. 3 discloses the present invention as prefabricated roll before installation on an object.

FIG. 1 discloses how present invention is used on an assorted steel construction consisting of deck or bulkhead 6 with a typical pipe 7 running to or through it. On a deck or bulkhead 6 a mat 1 is held in place by pins 5 (stud welded) on either end of the mat 1, allowing for the mat 1 to expand and protect against heat. When applied to the pipe 7 a mat 1 is normally glued 8 to the pipe and secured with at least one appropriate band 9 on the outside.

FIG. 2 discloses how present invention is used on a typical pipe 7 with a typical piping insulation 10. In this case is the mat 1 applied on the outside of the insulation without any glue applied, only secured with at least one appropriate band 9.

FIG. 3 discloses details of the invention. The fire protection according to the present invention consists of an expanding epoxy layer 2, arranged such that it can be prefabricated as mat and/or roll 4 prior to installation. The mat or roll 4 can be reinforced by a net 3 of different make or type, and the net 3 can be arranged on either of the outer surfaces or both (inside and/or outside, relative to the heat, when fitted) and/or within epoxy-material 2

One of the main advantages of this flexible fire protection relative to known art is that the mat 1 or roll 2 can be cut, shaped and fitted as required without loosing its properties. This makes the present invention easy to install on existing as well as new structures without the need for detailed knowledge of the shape and size of the object to be protected. Further more, since the present invention can be produced in rolls, it is easy to transport it to the object and do the fitting on location.

1. Means for fire protection of pipes, pipe joints, flanges, valves, insulation and steel constructions, wherein the fire protection is made flexible and made of heat expanding epoxy material with or without reinforcement.

2. Means according to claim 1, wherein the flexible fire protection can be prefabricated in a roll for easy transportation.

3. Means according to claim 1, wherein the flexible fire protection can be cut, shaped and fitted without loosing its properties.

4. Means according to claim 1, wherein the reinforcement is a net/mesh which can be of different type/shape and of different materials depending on desirable properties.

5. Means according to claim 2, wherein the flexible fire protection can be cut, shaped and fitted without loosing its properties.

6. Means according to claim 2, wherein the reinforcement is a net/mesh which can be of different type/shape and of different materials depending on desirable properties.

7. Means according to claim 3, wherein the reinforcement is a net/mesh which can be of different type/shape and of different materials depending on desirable properties.
